(19) United States
(12) Patent Application Publication
(10) Pub. No.: US 2026/0303382 A1
(43) Pub. Date: Oct. 1, 2026

(54) System and methods of Efficient Consensus Mechanism Utilizing Competitive Computational Races for Enhanced Network Security and Resource Optimization

(71) Applicant: LIBERMANS CO., Los Angeles, CA (US)

(72) Inventors: ANNA LIBERMAN WOODFORD, London (GB); DAVID LIBERMAN, Playa Vista, CA (US); DANIIL LIBERMAN, Playa Vista, CA (US); MARIA LIBERMAN, Los Angeles, CA (US)

(73) Assignee: LIBERMANS CO., Los Angeles, CA (US)

(21) Appl. No.: 19/544,794

(22) Filed: Feb. 19, 2026

Related U.S. Application Data
(60) Provisional application No. 63/760,745, filed on Feb. 20, 2025.

(51) Int. Cl. H04L 9/00

(52) U.S. Cl. CPC H04L 9/50; H04L 2209/463

(57) ABSTRACT

This invention presents a consensus mechanism that enhances network efficiency and security by optimizing resource utilization. By integrating a competitive Race that aligns voting power with computational contributions made during a confined timeframe, the mechanism addresses the inefficiencies of traditional PoW without relying on capital staking as in PoS. The mechanism ensures fairness, incentivizes meaningful computational work during specific periods, and maintains the integrity of the network through an honest majority.

### CROSS-REFERENCE TO RELATED APPLICATIONS

Priority is claimed on Provisional Patent Application No. 63/760,745, filed Feb. 20, 2025, the contents of which are incorporated herein by reference.

### STATEMENT REGARDING FEDERALLY SPONSORED RESEARCH OR DEVELOPMENT

Not Applicable

### REFERENCE TO A “SEQUENCE LISTING”, A TABLE, OR A COMPUTER PROGRAM LISTING APPENDIX SUBMITTED ON COMPACT DISC

Not Applicable

### BACKGROUND OF THE INVENTION

### 1. Field of the Invention

The present invention relates to a consensus mechanism for a Blockchain or the like and more particularly to a consensus mechanism that enhances network efficiency and security by utilizing a competitive computational process in which participants engage in computationally intensive tasks supporting Byzantine fault-tolerant consensus within defined, limited timeframe, whereby such tasks are not performed outside said timeframe, and in which the outcomes of these tasks serve as verifiable evidence of each participant's computational effort.

### 2. Description of Prior Art Including Information Disclosed Under 37 CFR 1.97 and 1.98

Blockchain networks rely on consensus mechanisms to maintain security, integrity, and agreement among distributed participants. The most prevalent mechanisms are Proof-of-Work (PoW) and Proof-of-Stake (POS).

In PoW systems like Bitcoin, network security is achieved by participants solving complex computational puzzles, where upon the successful solution of one puzzle, honest participants immediately begin solving the next puzzle, and this process continues continuously without interruption. Nodes strictly follow predefined consensus rules, and the network's integrity is upheld by the honest participation of nodes controlling more computational power than any cooperating attackers. However, this approach leads to significant inefficiencies. Massive resources are allocated not toward generating value but toward maintaining dominance in computational power, resulting in ever-growing consumption of energy and hardware with diminishing returns.

PoS was introduced to mitigate the computational costs and environmental impact associated with PoW. In POS systems, participants lock up cryptocurrency in a frozen account, with voting power distributed based on the amount staked. While PoS reduces energy consumption, it introduces significant capital costs and tends to reward capital holders over those contributing computational resources. Incentives are primarily directed toward capital rather than productive tasks, leading to inefficiencies in resource allocation. Both PoW and PoS have limitations in effectively determining an honest majority required for Byzantine fault-tolerant consensus (the security necessity for a distributed system to agree on a single, correct state, provided a majority of participants are honest, even if a minority of nodes fail or behave maliciously) without incurring substantial costs or inefficiencies. There is a need for a new consensus mechanism that optimizes resource utilization, reduces inefficiencies, and ensures fair and secure network operation without relying on the principles of either PoW or PoS.

### BRIEF SUMMARY OF THE INVENTION

The present invention introduces a novel consensus mechanism architecturally designed to enhance network efficiency and security by utilizing a competitive computational process called a “Race”. A Race is a defined short time period during which all participants simultaneously perform computationally demanding tasks that produce verifiable evidence of computational contribution; the verified evidence is used to determine voting weight for Byzantine fault-tolerant weighted consensus protocol under an honest-majority assumption. The Race workload is not continuous and is performed only during the Race window. The improvement in efficiency is achieved by strictly confining all computationally intensive activity, supporting Byzantine fault-tolerant consensus, to short, simultaneous, and periodically recurring computation windows, and by explicitly eliminating any requirement for computational work to achieve consensus outside such windows.

In this mechanism, participants engage in computational tasks, supporting consensus, only within a defined, limited timeframe. Between these computational-intensive window periods, the voting weights are assigned to each participant, representing the participant's relative influence in the consensus process. No additional computational-intensive operations are needed to achieve consensus between those window periods.

Improved efficiency is achieved by confining intensive computation, supporting consensus, to short simultaneous periodic or conditionally-scheduled windows, with no computation between the windows required to achieve consensus.

Participants engage in computational tasks, supporting consensus, only within a defined, limited time window, within which all computational influence on consensus is frozen until the next Race. The outcomes of these tasks serve as verifiable evidence of each participant's computational effort. Between computation windows, consensus is achieved exclusively through weighted voting based on previously established voting weights, without any ongoing or chained computational tasks.

Voting weight is allocated proportionally to valid computation effort performed within the designated window and is reused to govern consensus decisions for an extended period following the Race, until the end of the next cycle, during which no computation is required or permitted to influence consensus outcomes. This reuse of computational evidence beyond the computation window constitutes a core distinction from prior mechanisms that require continuous or immediately successive computational tasks to participate in consensus.

Accordingly, the voting weight in the consensus process is determined by the amount of valid computational evidence generated during the Race, adhering to a “computational contribution equals voting power” principle. Unlike traditional PoW systems, where continuous computational effort is required, this mechanism confines intensive computational work to a short period, optimizing resource usage and facilitating the allocation of computational resources toward External Productive Tasks, defined herein as computational workloads that provide utility external to the maintenance and security of the network, such as Artificial Intelligence (AI) inference, Large Language Model (LLM) training, or other high-performance computing applications, during intervening periods.

The Race begins simultaneously for all participants, ensuring fairness and preventing any timing advantages. Each new Race refreshes all voting weights, requiring fresh computational participation for continued influence and preventing the accumulation of long-term voting-weight advantage. A collaboratively generated random number serves as the unpredictable starting point, making it impossible to predict or influence in advance. This method ensures that no participant can gain an unfair advantage by starting early or manipulating the starting conditions.

This approach focuses on optimizing the use of computational resources by limiting the period during which intensive computation is required. It allows participants to utilize their resources for External Productive Tasks outside the Race period, enhancing overall network efficiency and sustainability.

The consensus mechanism of the present invention is designed for use with a Blockchain or similar network comprising multiple network participants. Each network participant's voting weight is based on the computational work performed during a defined short timeframe (“Race”).

Thus, intensive computation is confined to short, simultaneous periodic windows, with no computation between windows to achieve consensus. For example, the Race occurs at regular, precisely specified intervals synchronized with the creation of blockchain blocks, every N blocks, where N is a positive integer that represents a predetermined network parameter, such as the block height interval or the epoch duration. Alternatively, the initiation of the Race may follow a different pattern, such as being conditionally triggered by a collaboratively generated random number produced periodically by network participants, where the generated random value determines whether the Race is initiated within a given interval.

The Race is simultaneously started for all network participants by generating a random number collaboratively by all network participants with voting power. The random number is unpredictable and cannot be influenced or precomputed, ensuring fairness.

Participants engage in computationally demanding tasks, serving as evidence of computational contribution without requiring continuous resource expenditure. The computationally demanding tasks are designed to be easy to verify.

The outcomes of those tasks are compiled into computational evidence. Within the Race, participants submit their computational evidence to the network, where such evidence is distributed and verified by other network participants according to predefined verification rules. Voting weights are assigned proportionally only after successful verification, based on the computational evidence that has been validated through this distributed verification process. Each participant may act both as a producer of computational evidence and as a verifier of computational evidence produced by other participants, such that the determination of voting weight results from collective verification.

The allocated voting weights remain effective until the end of the cycle. A new Race determines the next set of weights for the subsequent cycle. Between the computational-intensive window periods, the weights are used for the consensus. No additional computation is needed to achieve consensus between these computational-intensive window periods.

Participants with allocated voting weights participate in validating new blocks. A block candidate is considered valid when approved by network participants representing a majority of the total voting weight.

### DETAILED DESCRIPTION OF THE INVENTION

### 1. Overview of the Consensus Mechanism:

The proposed consensus mechanism is designed to improve efficiency and security in blockchain networks by optimizing resource utilization. It centers around a structured, time-bound competition called the “Race”, which determines each participant's voting weight based on the computational work performed during this period.

A defining characteristic of the present invention is the strict temporal separation between computational activity and consensus execution.

In contrast to consensus mechanisms in which computational tasks are performed continuously or in immediately chained sequences, the disclosed mechanism enforces extended periods during which no computational contribution can influence consensus. Computational activity is confined exclusively to a short, predefined, or conditionally-triggered Race window. Once the Race concludes, all computational contribution to voting power is finalized. This architectural separation allows the network to determine weights representation once per cycle and to use that determination without further computation, thereby substantially reducing energy consumption and resource waste and facilitating the allocation of computational resources toward External Productive Tasks (e.g., AI inference or LLM training) during intervening periods.

### 2. The Race:

Initiation:
   The Race begins simultaneously for all network participants, akin to a starting gun in a physical race.
   A random number, generated collaboratively by all participants with voting power, serves as the starting point.
   This random number is unpredictable and cannot be influenced or precomputed, ensuring fairness.
Duration:
   The Race is confined to a short, defined timeframe (e.g., around 10 minutes). Intensive computation supporting Byzantine fault-tolerant consensus is permitted exclusively during the short simultaneous periodic or conditionally-triggered Race windows and is explicitly prohibited from influencing consensus outside that window; this restriction does not apply to External Productive Tasks (e.g., AI inference or LLM training), which can be performed during non-Race periods to maximize resource utility. Unlike systems in which a new computational task begins immediately after completion of a prior task, the conclusion of a Race terminates all computational contribution to consensus until the next scheduled or conditionally-triggered Race. This design ensures that computational tasks are not chained, continuous, or successively initiated, and that consensus remains independent of ongoing computation for the majority of the cycle duration.
   It can occur at regular, precisely specified intervals synchronized with the creation of blockchain blocks, for example, every N blocks. Alternatively, the occurrence of the Race may follow a different pattern, such as being conditionally initiated based on a collaboratively generated random number produced periodically by network participants, where the generated random value determines whether the Race is initiated during a given interval.
Computational Tasks:
   Participants engage in computationally demanding tasks designed to be resource-intensive but easy to verify.
   For example, similar to Bitcoin's PoW, where finding a nonce to produce a hash with a specific number of leading zeros requires significant computational effort.
   The tasks serve as evidence of computational contribution without requiring continuous resource expenditure.
Evidence Generation:
   The outcomes of these tasks are compiled into computational evidence.
   This evidence determines the voting weight each participant holds in the network.

### 3. Determination of Voting Weight:

Evidence Verification:
   Within the Race, participants submit their computational evidence.
   Other participants verify the validity and integrity of this evidence efficiently.
   The verified computational evidence is not used to directly propose or validate individual blocks, but instead is converted into voting weights that govern consensus decisions for an extended period following the Race. This distinction separates the act of computation from the act of consensus, allowing the network to use computational effort for External Productive Tasks (e.g., AI inferences and LLM training) between Races while maintaining security through previously established voting weights.
Voting Weight Allocation:
   Voting weights are assigned proportionally based on the verified computational evidence as soon as verification is completed.
   Reflects actual computational contributions rather than staked capital or continuous effort.
   Verification of computational evidence is executed in a short period following the conclusion of the Race. Computational Tasks, supporting Byzantine fault-tolerant consensus, are specifically configured for rapid verification to minimize the latency between the completion of a Race and the updating of voting weights for the subsequent cycle.
Duration of Voting Weights:
   Allocated voting weights remain effective until the end of the cycle.
   A new Race determines the next set of weights for the subsequent cycle.

### 4. Consensus Process:

Block Validation:
   Participants with allocated voting weights participate in validating new blocks.
   A block candidate is considered valid when approved by participants representing a majority of the total voting weight.
Ensuring an Honest Majority:
   By tying voting power to computational contributions during the Race, the mechanism ensures the honest majority controls consensus decisions.
   Prevents a minority from exerting disproportionate influence by relying on the same fundamental security assumption as standard Proof-of-Work systems, namely that an honest majority of participants following the protocol controls a majority of the available-computational power within a synchronized and time-bounded computation window.
Incentive Alignment:
   Participants are incentivized to contribute computational work during the Race to gain voting power.
   Aligns individual incentives with the network's overall efficiency and security.

### 5. Random Number Generation:

Collaborative Generation:
   The collaboratively generated random number may serve different functions within the consensus mechanism. In one embodiment, the random number defines a starting point for initiating a Race that is scheduled to occur. In an alternative embodiment, the random number determines whether a Race is initiated during a given interval, thereby conditionally enabling or skipping the Race for that interval.
   The random number initiating the Race is generated through a decentralized process involving all participants with voting power.
   Methods such as distributed key generation (DKG) or threshold cryptography ensure security.
Security Measures:
   The process prevents manipulation by any participant or minority group.
   Ensures the random number is unbiased and unpredictable until revealed to all simultaneously.

### 6. Advantages Over Traditional Mechanisms:

Efficiency:
   Focuses computational efforts within a limited timeframe.
   Avoids continuous energy consumption and resource wastage inherent in traditional PoW systems.
   Computational resources required for consensus are concentrated into short windows and remain available for External Productive Tasks, such as AI inference or LLM training, during the substantially longer non-computational periods.
Distinction from periodic Proof-of-Work:
   While certain prior mechanisms include periodic computational tasks, such systems initiate new tasks immediately upon completion of prior ones, maintaining continuous computational requirements.
   The present invention explicitly avoids such continuous computation (for maintaining protocol security) by enforcing long non-computational consensus periods between Races.
Fairness:
   Synchronous start of the Race eliminates timing advantages.
   Voting weight derived from computational evidence ensures that influence is proportional to computational work actually performed within the current computation window, rather than to capital ownership, or other non-computational advantages, such as previously accumulated voting weights, early participant status, or historical network participation. Unlike stake-based mechanisms in which influence may persist based on capital lock-up or historical allocation, voting weight in the present mechanism expires and must be re-earned through verifiable computation in each cycle.
Security:
   Maintains network security by ensuring the honest majority controls consensus.
   Prevents attacks by requiring significant computational effort within the Race period for influence.
   More efficiently achieves the same level of security as traditional consensus mechanisms by utilizing fewer resources.
Sustainability:
   Reduces the environmental impact associated with continuous high-energy consumption.
   Optimizes resource allocation, promoting long-term network sustainability.

Our invention results in a consensus mechanism that enhances network efficiency and security by optimizing resource utilization. By integrating a competitive Race that aligns voting power with computational contributions made during a confined timeframe, it addresses the inefficiencies of traditional PoW without relying on capital staking as in PoS. The mechanism ensures fairness, incentivizes meaningful computational work during specific periods, and maintains the integrity of the network through an honest majority.

While only a single preferred embodiment of the present invention has been disclosed for purposes of illustration, it is obvious that many modifications and variations could be made thereto. It is intended to cover all of those modifications and variations which fall within the scope of the present invention, as defined by the following claims.

1. A consensus mechanism for use with a Blockchain or similar network comprising multiple network participants, wherein each network participant's voting weight is based on the computational work performed during a defined short time period (“Race”), confining intensive computation to short simultaneous periodic or conditionally-initiated windows, without computation between the windows, to achieve consensus, comprising the steps of:
(a) simultaneously starting the Race for all network participants by generating a random number collaboratively by all network participants with voting power;
(b) participants engage in computationally demanding tasks, supporting Byzantine fault-tolerant consensus, only during Races, serving as evidence of computational contribution without requiring continuous resource expenditure; prohibiting any computational activity from influencing consensus outside the Race window;
(c) compiling the outcomes of the tasks into computational evidence, which determines the voting weight each participant holds in the network;
(d) participants submit their computational evidence within the Race, and
(e) voting weights are assigned proportionally to the participants based on the verified computational evidence upon Race completion and are reused to achieve consensus during a non-computational period following the Race.

2. The consensus mechanism of claim 1 wherein allocated voting weights remain effective until the end of the Race cycle.

3. The consensus mechanism of claim 2 wherein a new Race determines the next set of voting weights for the subsequent cycle.

4. The consensus mechanism of claim 1 wherein voting weights are assigned proportionally based on the verified computational evidence.

5. The consensus mechanism of claim 1 wherein said computationally demanding tasks are designed to be easy to verify.

6. The consensus mechanism of claim 1 wherein the random number is unpredictable and cannot be influenced or precomputed, ensuring fairness.

7. The consensus mechanism of claim 1 wherein the Race occurs at regular, precisely specified intervals synchronized with the creation of blockchain blocks (e.g., every N blocks).

8. The consensus mechanism of claim 1 wherein the tasks serve as evidence of computational contribution without requiring continuous resource expenditure.

9. The consensus mechanism of claim 1 wherein participants with allocated voting weights participate in validating new blocks.

10. The consensus mechanism of claim 1 wherein a block candidate is considered valid when approved by network participants representing a majority of the total voting weight.

11. The consensus mechanism of claim 1 wherein voting weight is allocated proportionally to valid computation effort performed within a designated window and uses that voting weight for consensus until the end of the next window.

12. The consensus mechanism of claim 1, wherein, between computational-intensive window periods, voting weights are used for the consensus, and no computation is needed to achieve consensus between those window periods.

13. The consensus mechanism of claim 1, wherein said windows occur at predetermined intervals or are conditionally initiated based on one or more dynamically determined conditions.
